(19) United States
(12) Patent Application Publication
(10) Pub. No.: US 2008/0151876 A1
(43) Pub. Date: Jun. 26, 2008

(54) Serverless peer to peer voice and data over internet protocol communications system

(76) Inventors: Ian A. Wilson, Port Orange, FL (US); Mohammed Mahmoud, Dayton Beach, FL (US)

Correspondence Address: Pennington, Moore, Wilkinson, Bell & Dunbar, P.A., Post Office Box 10095, Tallahassee, FL, 32302-2095, US

(21) Appl. No.: 12/002,969

(22) Filed: Dec. 19, 2007

Related U.S. Application Data
(60) Provisional application No. 60/876,024, filed on Dec. 20, 2006.

(51) Int. Cl. H04L 12/66

(52) U.S. Cl. 370/352

(57) ABSTRACT

A new system and method of operating VOIP connections without a server. The proposed system and method allows for communications between parties to be set up using an ad-hoc, peer-to-peer protocol. The communications can carry both voice encoded as data and data transmissions.

### CROSS-REFERENCES TO RELATED APPLICATIONS

This is a non-provisional application claiming the benefit pursuant to 37 C.F.R. §1.53(c) of an earlier-filed provisional application. The provisional application was filed on Dec. 20, 2006 and assigned Ser. No. 60/876,024. The provisional application listed the same inventors as the present application.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of communications. More specifically the present invention comprises a method and system for establishing serverless Voice Over Internet Protocol (VOIP) connections.

2. Description of the Related Art

Voice communication in which the speech is sampled into digital form and coded for data transmission using Internet Protocols (IP) is becoming commonplace. The technology is referred to as “Voice Over Internet Protocol” (VOIP). The phrase “Internet protocol” refers to the method of organizing the data transmission over the transmission medium. The transmission medium can assume many forms, including electrical conductors, fiber optic cables, radio transmissions, and satellite transmissions.

Commercial telecommunications providers are currently marketing VOIP telephone systems that run over the publicly available Internet. There are also specialized providers that are providing VOIP systems for use in aircraft and as ‘party-line’ voice communication links between the parties that are end-users. These systems all use a management facility or ‘server’ to manage the connections between the parties and in some cases to manage the actual communications.

In some circumstances, however, using a server to host the communications is impractical or otherwise undesirable. This is particularly true where communicating parties are geographically close but the server hosting the communications is remotely located. The use of a geographically remote server increases the delay between the time a communication is sent and the time the communication is received. Also, in the event of server failure or disconnection, communication cannot continue between the communicating parties. Accordingly, it would be desirable to have a mechanism for establishing VOIP connections without using a server.

### BRIEF SUMMARY OF THE INVENTION

The present invention comprises a new method and system of operating VOIP connections without a server. The proposed system and method allows for communications between parties to be set up using an ad-hoc, peer-to-peer protocol. The communications can carry both conventional digital data and voice communications encoded as digital data.

Using the proposed method and system, a serverless VOIP (“SVOIP”) connection is initiated when a first user submits a transmission over any available Internet protocol (“IP”) connection requesting another party to respond. If there is a response then the first user's computer and the responding party's computer negotiate directly to set up the data-links for data and voice. The “peer parties” thereafter cooperatively manage the communications.

The first system to attempt to connect and not receive an answer (i.e., the first of the group of serverless VOIP systems to be available) will automatically assume the control of the VOIP protocols between the peer systems. This control will continue until either that serverless VOIP system breaks its connection or a system joins the group that has been pre-designated as a “Master” system. The first such Master system to join the group will take on the task of control of the serverless VOIP protocols between the peer systems.

In the preferred embodiment, the system managing the communication provides various functions. One function is “step-on prevention.” Step-on prevention prevents parties from transmitting over each other. This ensures that a transmitting party is heard clearly. A second function is “Master party preemption.” This function allows the controlling party (i.e., the Master) to enforce muting on all other parties, preempting all other transmissions, whenever the controlling party transmits a voice message. A third function is “identification of connected parties.” As the connection protocol connects new users into the system, information is fed back to the current users such that the identity of connected users in the group may be displayed to each user.

Using the proposed method and system, information that is in the form of data, such as text messages, may be sent over the control channel to other parties either as a broadcast to all parties or as an addressed message to a single party. Voice communications may always be heard by all parties connected through a particular ‘port’ on an IP address.

In the preferred embodiment, the peer-to-peer communications employ User Datagram Protocol (“UDP”)-Multicast. Such an approach is advantageous for various reasons. First, the system is expandable over any multicast enabled network. Second, a network of peers is easily and almost limitlessly scalable, as well as being more reliable than a single server. Third, the multicast approach reduces network traffic as the message is only sent once and the network splits and copies it as necessary. Accordingly, messages need not be separately sent to each user. Finally, there is no single point of failure. In the SVOIP approach one or more peers can fail or lose contact with the group and the group will still continue to function.

### BRIEF DESCRIPTION OF THE SEVERAL VIEWS OF THE DRAWINGS

FIG. 1 is a block diagram, illustrating the present invention.

FIG. 2 is a block diagram, illustrating the present invention.

FIG. 3 is a block diagram, illustrating the present invention.

FIG. 4 is a block diagram, illustrating the present invention.

REFERENCE NUMERALS IN THE DRAWINGS

| | | | |
|---|---|---|---|
| 10 | first user | 12 | second user |
| 14 | data link | 16 | third user |
| 18 | UDP Multicast | 20 | Master user |
| 22 | user interface | 24 | main application |
| 26 | transmit switch | 30 | input transducer |
| 32 | listening subsystem | 34 | sending subsystem |
| 36 | speaker | 38 | record-and-send subsystem |
| 40 | receive-and-play subsystem | 42 | network interface |

### DETAILED DESCRIPTION OF THE INVENTION

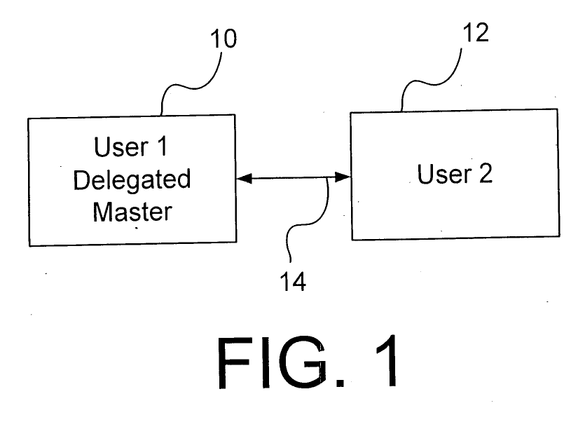

FIGS. 1-3 are illustrative of the connectivity possibilities of the current invention. The actual communications equipment used is not a novel part of the current invention. The only requirement is that the connections and network have the capacity to carry the data from the current invention.

As illustrated in FIG. 1, first user 10 and second user 12 may communicate directly with each other using data link 14. As mentioned previously, data link 14 may be any means suitable for the transmission of data between two systems (electrical conductors, fiber optic cables, radio transmissions, satellite transmissions, etc.). In this example, first user 10 is delegated as the “Master” because first user 10 was the first user to submit a transmission over data link 14 requesting another party to respond. As “Master,” first user 10 is the controlling party of the connection. First user 10's system will carry out various management functions which will be described in greater detail subsequently.

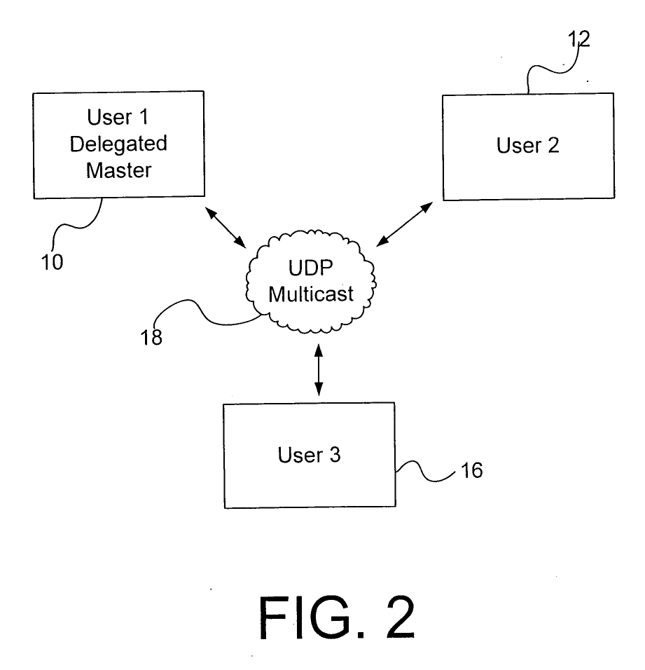

As illustrated in FIG. 2, peer parties communicate via UDP Multicast 18 when third party 16 joins the connection. UDP Multicast is the preferred data communication protocol when there are more than two parties to the connection. Assuming third user 16 is not a pre-designated “Master,” first user 10 will retain its status as the controlling party of the connection.

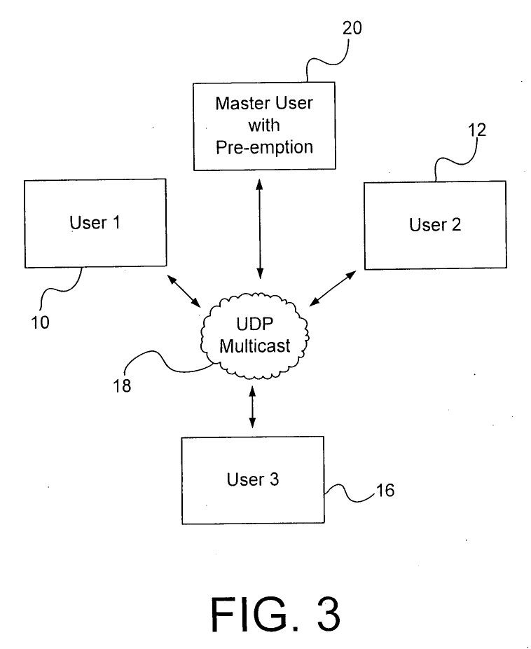

As illustrated in FIG. 3, first user 10 loses its status as controlling party when Master user 20, a pre-designated “Master,” joins the connection. Master user 20 takes over management responsibility for the connection and has the ability to enforce muting or preemption over the transmissions of first user 10, second user 12, and third user 16 anytime Master user 20 transmits a voice message.

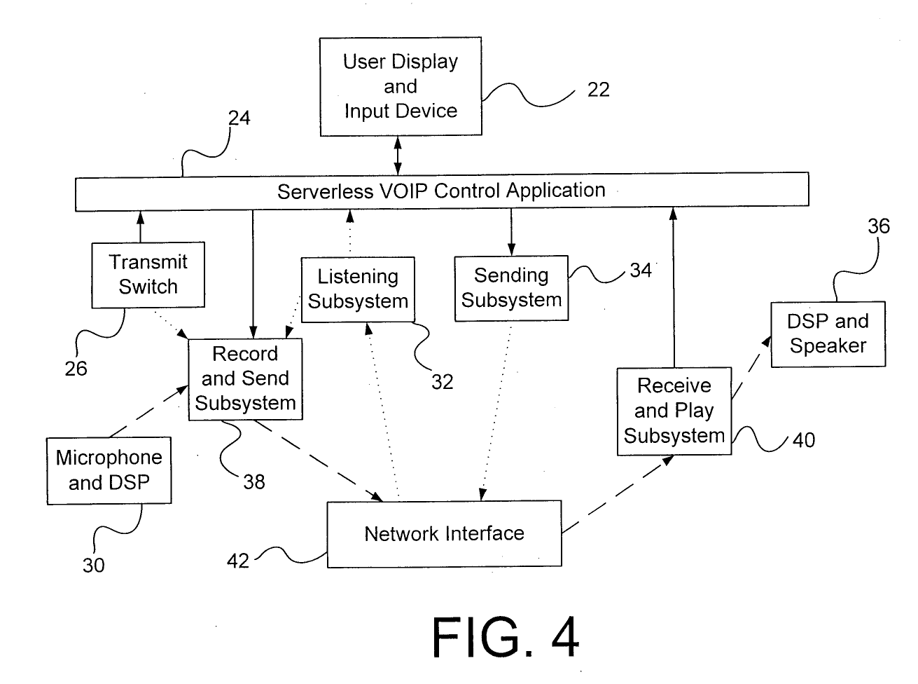

In the foregoing examples each user communicates with the peer parties via a computer system running a serverless VOIP application. The serverless VOIP application will now be considered in greater detail. FIG. 4 is a diagrammatic representation of the subsystems of a serverless VOIP application used in the present invention. In FIG. 4, the solid arrows indicate internal process data. Arrows with dashed lines indicate sound transmitted as data (such as voice communications), and arrows having dotted lines indicate the transmission of protocol and data.

The general operation of the system will now be described. More specific examples follow. Upon start-up of the application, main application 24 initiates all subsystems, including listening subsystem 32, sending subsystem 34, receive-and-play subsystem 40, and record-and send-subsystem 38. Main application 24 then transmits information to user interface 22, informing the user that the system is ready.

Main application 24 manages the operation of all the subsystems within the serverless VOIP application. User interface 22 includes a display and an input device which may be used to control the application. User interface 22 may include a touch screen, a keyboard or any other device suitable for inputting data or text.

Network interface 42 carries out the low level internet network protocols to find and link to a data link communications port suitable for multicast. Network interface 42 transmits output data as UDP-multicast. It also receives multicast data packets from the network transmitted by peer parties. When network interface 42 has connected to a network, sending subsystem 34 sends an initial protocol message requesting a response from any “equivalent” serverless VOIP system on the connected network. Any response protocol message is routed by network interface 42 to the listening subsystem 32. If the response is a connection, then main application 24 initiates the connection process through sending subsystem 34.

Listening subsystem 32 and sending subsystem 34 are thus responsible for the protocol management of connection and link management. Listening subsystem 32 receives inbound data such as connection protocols or inbound data. This inbound data is transmitted to main application 24 for processing. If, however, the inbound data is a command, such as a “mute” or “unmute” control message, listening subsystem 32 may distribute the command to the pertinent subsystems directly. Sending subsystem 34 is responsible for initiating the connection protocols and also initiates “mute” and “unmute” messages if the system is a Master system or Delegated Master, as will be explained subsequently.

The connection protocol is managed by the main application 24, including the delegation of Master status if no Master is present on the connection. More than one response can be received through the protocol and each responding remote system is indicated on user interface 22 for the user's information.

When the display indicates the presence of another party to the connection, the user presses transmit switch 26 and speaks into the microphone of input transducer 30. Transmit switch 26 may be a simple “push to talk” switch or a voice initiated switch that operates automatically when the user speaks. The analogue output from the transducer—which is typically a microphone—is fed through a Digital Signal Processor (DSP) where it is converted to digital data and sent to record-and-send subsystem 38. Record-and-send subsystem 38 compresses the data received to reduce the bandwidth required and then breaks the transmitted data into packets for efficient use by the network and sends the packet stream to network interface 42.

On receipt of encoded voice data, network interface 42 routes the packets to receive-and-play subsystem 40. Receive-and-play subsystem 40 then rebuilds the stream of voice digital data by concatenating the packets of data then decompressing the data stream. The decompressed voice data stream is then sent to a DSP for output to speaker 36. When the first packet is received, receive-and-play subsystem 40 concurrently sends a control message to main application 24, indicating that a packet has been received. If the local system is a Master or delegated Master, main application 24 sends a mute request signal to sending subsystem 34. Sending subsystem 34 responds by issuing a protocol “mute” message through network interface 42 to all connected user systems except the system that sent the received packet. In this way, although there may be a few packets that collide, the system prevents “step on” between two transmitting users.

If a system is not the Master or a delegated Master and a mute message is received by network interface 42, the control message is routed to listening subsystem 32, which passes the mute message onto record-and-send subsystem 38. In response, record-and-send subsystem 38 immediately ceases to pass packets to the network interface 42.

If a system is a Master or delegated Master system, then Master main application 24 triggers the application to send a “mute all” message to sending subsystem 34 (which transmits the “mute all” control message to network interface 42 for multicast) when the user presses the transmit switch 26. A Master system or delegated Master system ignores any mute messages if it is transmitting.

When the user deselects transmit switch 26, indicating the end of a transmission, record-and-send subsystem 38 finishes sending the data stream that had been produced and issues an “end of transmission” message to main application 24. Main application 24 then initiates an “unmute” by signaling sending subsystem 34. Sending subsystem 34 responds by sending an “unmute” message to all connected systems. In this way the transmitting system is responsible for allowing other systems to start sending again.

User interface 22 can be used to transmit data or messages to one or more of the connected systems. These data messages are routed to main application 24 which forwards the data messages to sending subsystem 34. The data is then broken into packets, if necessary, and passed to network interface 42, where the data is transmitted to the appropriate recipient(s).

Peer parties connected through a common connection are considered “groups.” There are various ways that a user of the proposed serverless VOIP application may “move” between groups. The movement may be initiated by the user or a pre-designated Master. A user wishing to initiate a move to another group enters the multicast IP address or a name or symbol that stands for the multicast IP address of the group to move to on user interface 22. The request information is passed to the main application 24. Main application 24 then passes a disconnect message to sending subsystem 34 which issues a disconnect message to the network interface 42 for transmission to the entire group. Main application 24 then resets the system to a new multicast IP address and issues a connect request to sending subsystem 34 which passes the multicast address change to the network interface 42. The system then connects to the new address as described previously for the initial connection.

The user of the Master system may also move another user from one group to another group. The Master system does this by issuing a “Change Multicast IP address” control message to the other user's system. The Master user may do this by entering the details of the transfer through the Master user's user interface 22. The information of the Master user's request is passed to main application 24. This issues a “Change Multicast IP address” command to sending subsystem 34 which transmits the “Change Multicast IP address” command message to network interface 42. On receipt of the “Change Multicast IP address” command message, the other user's network interface 42 passes the command to listening subsystem 32 which passes the command to main application 24. Main application 24 then passes a disconnect message to sending subsystem 34, which transmits a disconnect message to network interface 42 for transmission to the entire group. Main application 24 then resets the system to the new multicast IP address and issues a connect request to the sending subsystem 34 which passes the multicast address change to network interface 42. The system then connects to the new address as described previously with respect to the initial connection.

As mentioned previously, there can only be one Master system in a connected group. The first system to join an IP address acts as a delegated Master system until a pre-designated Master system joins the group. If no pre-designated Master system joins the group, the first system acting as delegated Master remains the Master until the system leaves the group. At that time, the delegation of “Master” is passed to the system in the group that has been in the group the longest. This protocol delegation control message is received by the network interface 42 and is passed to listening subsystem 32 which sets internal parameters to show that it is a “Delegated Master” and passes this information to main application 24. The system then acts as the group Master managing “step on” prevention. If the system is a pre-designated Master it may also now pre-empt other transmissions.

Systems in the group send “I am alive” messages to the peer systems at defined time intervals. These messages are initiated by sending subsystem 34. Network interface 42 sends these “I am alive” messages to listening subsystems 34 which times their arrival. If a user wishes to disconnect, the user initiates a “disconnect” input into user interface 22. This disconnect message is read by main application 24 and is transmitted to the sending subsystem 34 which transmits the disconnect message via the network interface 42.

If a disconnect message is received or an “I am alive” message is not received from a system in two successive time intervals, listening subsystem 34 sends a “system ID has disconnected” message to main application 24 which removes the disconnected system from the user interface 22. It is noted that for appropriate fault tolerance, and because UDP-Multicast messages can be lost in a busy network, control messages may be replicated a designated number of times to ensure their receipt.

### EXAMPLE ONE

The operation of the current invention may be better understood by exploring an example in which a group of users is incrementally assembled, starting with a small local group and working up to a large network. This example initially considers a pair of helicopters on the ground in a remote region.

The two helicopters are in communication with a radio link and one user starts up its serverless VOIP (SVOIP) application (The term “application” is understood to include software running on associated hardware). The application sets up two data channels on the local communication system. One channel, the supervisory channel, will be for the transmission of control signals and data, and the other will be for the transmission of voice encoded as data. The SVOIP application then transmits a query on the supervisory channel over the radio link using a pre-assigned port and IP “address” to see if any SVOIP applications are present. As there is no answer (since the second helicopter has not yet initiated its SVOIP system) the SVOIP application will display a blank screen to the user and—in the absence of any other SVOIP party—the SVOIP system in the first helicopter assumes the role of Master system.

When the second SVOIP system starts up it follows the same set of actions. The application sets up two data channels on the local communication system. One channel, the supervisory channel, will be for the transmission of control signals and data, and the other will be for the transmission of voice encoded as data. The second SVOIP application then transmits a query on the supervisory channel over the radio link using a pre-assigned port and IP “address” to see if any SVOIP applications are present. The system receives an answer from the first system present. Because a system is already there the second system will not be the delegated-Master system.

Once there is more than one system, the systems may authenticate that they are “allowed” to connect with the other party and that the other party is genuine and then both display to their respective users the identity of the connected party. The authentication procedure is not part of the current invention and is expected to be standard for that type of communications link. Accordingly, a more thorough discussion of the authentication procedure is omitted herein.

Once authentication is complete, the systems then set up read and play sound applications on the voice-as-data link. The two parties may now talk to each other and transmit data. The data is transmitted between the two parties as UDP multicast.

If a third SVOIP party (for example, a person carrying a portable radio pack with SVOIP capability) joins the SVOIP group, then that user's SVOIP application follows the same procedure as for the second. The third user's display shows that there are already two users in the group and that the third user is added. The number of users joining the group is effectively limited only by the bandwidth of the communications link as all users are “listening” to the same port on a multicast IP address.

The original first user, the “delegated Master,” manages the transmissions of all users. When a Master or delegated-Master receives a voice data transmission it sends a mute command on the data channel to all non-transmitting parties. This message prevents the non-transmitting parties from transmitting at the same time and “stepping-on” the transmitting party's transmission. If the first user leaves the group, then the first user would “delegate” one of the other standard users as the delegated Master. In the present example, the second helicopter would be delegated Master since it has been in the group the longest.

If a fourth user joins the group (for example, a fixed wing aircraft flying at high level) then that user's SVOIP application follows the same procedure as for the third. The user display shows that there are already three users in the group and the fourth user is added. However, the fixed wing aircraft has been predefined as a “Master system.” It is identified as such by the protocol messages it sends on connection to the group. Since there is no response from a previously present Master system, the fourth user becomes the Master system and the first user reverts to being a normal user. As a predefined Master system, the fixed wing aircraft user can transmit at any time muting all other transmissions by other group members, pre-empting them.

It is noted that if the users in the current example had been using satellite communications they could be anywhere in the world and the same protocols could be used.

### EXAMPLE TWO

The following example considers the field of airlines. In this example, an aircraft dispatcher is pre-designated as a Master system. The dispatcher is able to contact and talk with all aircraft worldwide, or contact and talk to just one aircraft. Dispatchers are typically involved with aircraft route planning, fuel management, weather avoidance, traffic management, and similar things.

In this example, a first aircraft (Aircraft One) starts up and its communications system makes contact with the underlying network. Aircraft One's main application 24 starts up, initiating all of the subsystems. When the sending subsystem 24 starts, it initiates a protocol message onto the network to a pre-stored multicast-IP or one put in by the user through user interface 22. A protocol message announcing the presence of Aircraft One on the network, its ID, and requesting response is sent out onto the network through the network interface 42 to the multicast IP preset or selected by the pilot via input to user interface 22.

Assuming that the pre-designated Master is not on-line, no response will be received. In that case, Aircraft One's SVOIP application defaults to “delegated Master” status. No further action is taken by Aircraft One's system and the display remains blank showing that no other SVOIP systems are on that IP.

A second aircraft, Aircraft Two, starts up and its communication system makes contact with the underlying network. Aircraft Two's SVOIP main application then starts, initiating all of the subsystems. When sending subsystem 34 starts, it initiates a protocol message onto the network to a pre-stored multicast-IP or one put in by the pilot through the user interface 22. A protocol message announcing the presence of Aircraft Two on the network, its ID, and requesting response from any other system is sent out onto the network through the network interface 42 to the multicast IP preset or selected by the pilot via input to user interface 22.

The protocol message from Aircraft Two is received by Aircraft One's network interface 42. It is then transmitted to listening subsystem 32 which sends the new ID to Aircraft One's user interface 22. Aircraft One's main application 24 initiates a response protocol message through sending subsystem 34 announcing: (1) its presence on the network, (2) Aircraft One's ID, and (3) the fact that Aircraft One is the delegated Master. The message is sent to Aircraft One's network interface 42 and transmitted on the network.

Aircraft Two's system receives the response message from Aircraft One at Aircraft Two's network interface 42. Aircraft Two's network interface 42 sends the response message to listening subsystem 32 which passes the protocol messages to main application 24. Main application 24 in Aircraft Two then sends Aircraft One's ID to Aircraft Two's user interface 22. The reader will note that both aircraft systems are now displaying the other's ID on their respective user interfaces.

If the pilot of Aircraft Two presses transmit switch 26 and talks into the microphone, the indication that the transmit button is pressed is sent to main application 24 and displayed on user interface 22. The pilot's speech is transmitted as a stream of voice-encoded-as-data from input transducer 32 to record-and-send subsystem 38. Record-and-send subsystem 38 compresses the data, puts it into small packets suitable for the network, and then sends the packet stream to network interface 42 which transmits the packet stream onto the network.

Aircraft One's network interface 42 receives the voice data packet stream and passes it to its receive-and-play subsystem 40. Aircraft One's receive-and-play subsystem 40 extracts the data from the packets, decompresses the data, and sends the data stream to speaker 36. Receive-and-play subsystem 40 also signals to Aircraft One's main application 24 that a message from Aircraft Two is being received. Since it is a delegated Master System, Aircraft One's main application 24 initiates a “mute” protocol message to all users except Aircraft Two. A “Mute All Except Aircraft Two” message is transmitted from Aircraft One's main application 24 to sending subsystem 34 which transmits the message to network interface 42 where it is then broadcast on the network.

Next the Dispatcher arrives and initiates his or her system. The Dispatcher's communications system makes contact with the underlying network. The Dispatcher's main application 24 starts up, initiating all of the subsystems. When sending subsystem 34 initiates, it transmits a protocol message onto the network to a pre-stored multicast-IP or one put in by the user through the Dispatcher's user interface 22. A protocol message announcing (1) the presence of the Dispatcher's main application on the network, (2) its ID, and (3) its status as a predefined Master system. A response request is then sent out onto the network through network interface 42.

The Dispatcher's protocol message is received by Aircraft One's network interface 42 which transmits to listening subsystem 32. The Dispatcher's ID is transmitted to Aircraft One's user interface 22. Aircraft One's main application 24 initiates a response protocol message through sending subsystem 34, announcing Aircraft One's presence on the network and Aircraft One's ID. This message is sent through Aircraft One's network interface 42. Aircraft One's main application 24, on receipt of the Dispatchers pre-defined Master message, relinquishes its role as delegated Master.

The Dispatcher protocol message is also received by Aircraft Two's network interface 42 which transmits the message to listening subsystem 32. The Dispatcher's ID is transmitted to Aircraft Two's user interface 22. Aircraft Two's main application 24 initiates a response protocol message through sending subsystem 34, announcing Aircraft Two's presence on the network and Aircraft Two's ID. This message is sent through Aircraft Two's network interface 42. The Dispatcher system and the Aircraft systems are now aware of the others on the multicast IP and show the presence of the other systems on their respective user interfaces 22.

Any of the connected users may initiate text and other data messages via their user interfaces 22 or from other external inputs to their main applications 24. The data is sent to sending subsystem 34, which compresses the data and breaks it into packets suitable for the network. The data is then sent to the network interface 42 addressed to either an individual connected user or to all connected users. This data continues to be sent interleaved with any Voice encoded as data.

### Step-On Prevention

If the pilot of Aircraft One presses transmit switch 26 and talks into the microphone, the indication that the transmit button is pressed is sent to main application 24 and displayed on user interface 22. The pilot's speech is transmitted as a stream of voice encoded as data from input transducer 30 (which is associated with a DSP) to record-and-send subsystem 38. Record-and-send subsystem 38 compresses the data, puts it into small packets suitable for the network, and then sends the packet stream to network Interface 42 which transmits the packet stream onto the network.

The Dispatcher's network interface 42 receives the voice data packet stream and passes it to receive-and-play subsystem 40. Receive-and-play subsystem 40 extracts the data from the packets, decompresses the data, and sends the data stream to speaker 36. Receive-and-play subsystem 40 also signals to the Dispatchers main application 24 that a message from Aircraft One is being received. As it is a Master System, the Dispatcher's main application 24 initiates a “mute” protocol message to all users except Aircraft One. This message is transmitted to sending subsystem 34 which transmits the message to network interface 42 where it is then broadcast on the network.

Aircraft Two's network interface 42 receives the voice data packet stream and passes it to its receive-and-play subsystem 40. Aircraft Two's receive-and-play subsystem 40 extracts the data from the packets, decompresses the data, and sends the data stream to Aircraft Two's speaker 36. Aircraft Two's receive-and-play subsystem 40 also signals to Aircraft Two's main application 24 that a message from Aircraft One is being received.

Aircraft Two's network interface 42 receives the “Mute All Except Aircraft One” protocol message from the Dispatcher and passes it to listening subsystem 32. Listening subsystem 32 signals to Aircraft Two's main application 24 that a “Mute All Except Aircraft One” message from the Dispatcher Master system is being received. Aircraft Two's listening subsystem 32 initiates a “mute” message to Aircraft Two's record-and-send Subsystem 38 which prevents Aircraft Two's pilot from being able to transmit.

### Preemption

If Aircraft One continues transmitting for a long period and the Dispatcher (as pre-defined Master) wishes to transmit, the dispatcher may preempt or interrupt Aircraft One's transmission. The Dispatcher presses transmit switch 26 and talks into input transducer 30. An indication that transmit button 26 is pressed is sent to the main application 24 and displayed on user interface 22. Because it is a pre-defined Master system, the Dispatcher's main application 24 initiates a “mute” protocol message to all users. Main application 24 does this by transmitting the “mute” command to sending subsystem 34 which transmits the “mute all” message to network interface 42 where it is then broadcast on the network. The Dispatcher's speech is transmitted as a stream of voice-encoded-as-data from input transducer 30 to record-and-send subsystem 38. Record-and-send subsystem 38 compresses the data, puts it into small packets suitable for the network, and then sends the packet stream to the network Interface 42 which transmits the packet stream onto the network.

Network interfaces 42 of Aircraft One and Aircraft Two receive the “mute all” protocol message and pass it to their respective listening subsystem 32. Each listening subsystem 32 signals its respective main application 24 that a “mute all” message from the Dispatcher Master system is being received. Each Listening subsystem 32 initiated a “mute” message to its respective record-and-send subsystems 38 which prevents the aircraft pilots from being able to transmit. Aircraft One's transmission is interrupted and muted by the receipt of the “mute” message.

The preceding description contains significant detail regarding the novel aspects of the present invention. It should not be construed, however, as limiting the scope of the invention but rather as providing illustrations of the preferred embodiments of the invention. For example, the preceding description generally describes a process whereby an “agreed upon” protocol is used to set up Voice Over Internet Protocol (VOIP) connections between cooperating systems. The preferred embodiment accomplishes this by (1) providing protocols for identifying a Master system where none is specified; (2) managing the connection and operation of the data and voice as data transmission between cooperating systems; (3) providing to the cooperating systems information that is displayed to the user on the status of their connection and the identities of peer systems; (4) encoding voice-as-data and transmitting that data to the other connected parties by multicast; (5) receiving voice-as-data and decoding that data into voice for the recipient parties; (6) transmitting and receiving and acting on control data signals between the peer parties; and (7) transmitting information as data between the peer parties.

The invention assumes that there is a suitable communications link between the parties. This may be any link that can carry signals, including a telephone line, a close beam laser link or a satellite communications link. This link is preferably capable of carrying User Datagram Protocol (UDP) multicast messages. If the network is not multicast capable, then a Transmission Control Protocol (TCP)/Internet Protocol (IP) tunnel can be employed to carry the transmissions between the parties. Thus, the scope of the invention should be fixed by the following claims, rather than by the examples given.

Having described our invention, we claim:

1. A method of providing serverless peer to peer voice and data communications, comprising:
a. providing a data link capable of transmitting digital data to multiple users;
b. providing each of said multiple users with a SVOIP application running on a computer in the possession of each of said multiple users;
c. initiating said SVOIP application on a first user's computer, whereupon said SVOIP application on said first user's computer logs into said data link;
d. designating said first user as the master user;
e. establishing two communication channels across said data link, with a first communication channel being configured to carry control signals and data and a second communication channel being configured to carry voice encoded as data;
f. initiating said SVOIP application on a second user's computer, whereupon said SVOIP application on said second user's computer logs into said data link;
g. using said SVOIP application on said master user's computer to manage transmissions over said first and second communication channels; and
h. transmitting control signals and data between said multiple users over said first communication channel; and
i. transmitting voice encoded as data between said multiple users over said second communication channel.

2. A method of providing serverless peer to peer voice and data communications as recited in claim 1, wherein said step of managing said transmissions over said first and second communication channels comprises said SVOIP application on said master user's computer transmitting control signals to all other SVOIP applications logged into said data link.

3. A method of providing serverless peer to peer voice and data communications as recited in claim 1, further comprising:
a. designating a predefined master user;
b. in the event that said predefined master user logs into said data link, preempting said existing master user in favor of said predefined master user;
c. thereafter using said SVOIP application on said predefined master user's computer to manage transmissions over said first and second communication channels.

4. A method of providing serverless peer to peer voice and data communications as recited in claim 1, further comprising:
a. establishing a hierarchy of users according to the length of time each of said users has been logged into said data link, with a user having a longer length of time logged in being senior to a user having a shorter length of time logged in; and
b. in the event that the user currently designated as the master user logs off said data link, designating the remaining user having the highest seniority as said master user.

5. A method of providing serverless peer to peer voice and data communications as recited in claim 1, wherein when a user transmits a message to said data link, said master user's SVOIP application transmits a control signal over said first communication channel muting transmissions from all other users.

6. A method of providing serverless peer to peer voice and data communications as recited in claim 1, wherein said signals transmitted over said first and second communication channels assume the form of UDP multicast messages.

7. A method of providing serverless peer to peer voice and data communications as recited in claim 2, wherein said signals transmitted over said first and second communication channels assume the form of UDP multicast messages.

8. A method of providing serverless peer to peer voice and data communications as recited in claim 3, wherein said signals transmitted over said first and second communication channels assume the form of UDP multicast messages.

9. A method of providing serverless peer to peer voice and data communications as recited in claim 4, wherein said signals transmitted over said first and second communication channels assume the form of UDP multicast messages.

10. A method of providing serverless peer to peer voice and data communications as recited in claim 1, wherein:
a. each of said SVOIP applications performs its functions by interfacing with
i. a record and send subsystem,
ii. a listening subsystem,
iii. a sending subsystem,
iv. a receive and play subsystem, and
v. a user display and input device;
b. said listening subsystem monitors said first communication channel for said control signals; and
c. said listening subsystem is capable of directly muting said record and send subsystem in response to an appropriate control signal.

11. A method of providing serverless peer to peer voice and data communications as recited in claim 10, wherein:
a. said user display and input device includes a visual display for indicating all of said users that are currently logged into said data link and an alphanumeric input device; and
b. said record and send subsystem includes an auditory input device.

12. A method of providing serverless peer to peer voice and data communications as recited in claim 2, wherein:
a. each of said SVOIP applications performs its functions by interfacing with
i. a record and send subsystem,
ii. a listening subsystem,
iii. a sending subsystem,
iv. a receive and play subsystem, and
v. a user display and input device;
b. said listening subsystem monitors said first communication channel for said control signals; and
c. said listening subsystem is capable of directly muting said record and send subsystem in response to an appropriate control signal.

13. A method of providing serverless peer to peer voice and data communications as recited in claim 12, wherein:
a. said user display and input device includes a visual display for indicating all of said users that are currently logged into said data link and an alphanumeric input device; and
b. said record and send subsystem includes an auditory input device.

14. A method of providing serverless peer to peer voice and data communications as recited in claim 3, wherein:
a. each of said SVOIP applications performs its functions by interfacing with
i. a record and send subsystem,
ii. a listening subsystem,
iii. a sending subsystem,
iv. a receive and play subsystem, and
v. a user display and input device;
b. said listening subsystem monitors said first communication channel for said control signals; and
c. said listening subsystem is capable of directly muting said record and send subsystem in response to an appropriate control signal.

15. A method of providing serverless peer to peer voice and data communications as recited in claim 14, wherein:
a. said user display and input device includes a visual display for indicating all of said users that are currently logged into said data link and an alphanumeric input device; and
b. said record and send subsystem includes an auditory input device.

16. A method of providing serverless peer to peer voice and data communications as recited in claim 4, wherein:
a. each of said SVOIP applications performs its functions by interfacing with
i. a record and send subsystem,
ii. a listening subsystem,
iii. a sending subsystem,
iv. a receive and play subsystem, and
v. a user display and input device;
b. said listening subsystem monitors said first communication channel for said control signals; and
c. said listening subsystem is capable of directly muting said record and send subsystem in response to an appropriate control signal.

17. A method of providing serverless peer to peer voice and data communications as recited in claim 16, wherein:
a. said user display and input device includes a visual display for indicating all of said users that are currently logged into said data link and an alphanumeric input device; and
b. said record and send subsystem includes an auditory input device.

18. A method of providing serverless peer to peer voice and data communications as recited in claim 5, wherein:
a. each of said SVOIP applications performs its functions by interfacing with
i. a record and send subsystem,
ii. a listening subsystem,
iii. a sending subsystem,
iv. a receive and play subsystem, and
v. a user display and input device;
b. said listening subsystem monitors said first communication channel for said control signals; and
c. said listening subsystem is capable of directly muting said record and send subsystem in response to an appropriate control signal.

19. A method of providing serverless peer to peer voice and data communications as recited in claim 18, wherein:
a. said user display and input device includes a visual display for indicating all of said users that are currently logged into said data link and an alphanumeric input device; and
b. said record and send subsystem includes an auditory input device.

20. A method of providing serverless peer to peer voice and data communications as recited in claim 3, further comprising:
a. establishing a hierarchy of users according to the length of time each of said users has been logged into said data link, with a user having a longer length of time logged in being senior to a user having a shorter length of time logged in; and
b. in the event that the user currently designated as the master user logs off said data link, designating the remaining user having the highest seniority as said master user.
